(19) United States
(12) Patent Application Publication
(10) Pub. No.: US 2018/0040092 A1
(43) Pub. Date: Feb. 8, 2018

(54) LOGISTICS SYSTEM AND METHOD FOR MANAGING OBJECTS IN A SPACE

(71) Applicant: Rakkatec Oy, Helsinki (FI)

(72) Inventor: Jarkko VALTANEN, Helsinki (FI)

(21) Appl. No.: 15/535,162

(22) PCT Filed: Dec. 14, 2015
(86) PCT No.: PCT/FI2015/050878

§ 371 Date: Sep. 28, 2017

(30) Foreign Application Priority Data
Dec. 12, 2014 (FI) 20146092

(51) Int. Cl. G06Q 50/28; B65G 67/02; B65G 67/60; B65G 1/137

(52) U.S. Cl. CPC G06Q 50/28; B65G 1/137; B65G 67/02; B65G 67/60

(57) ABSTRACT

A logistics system for managing objects in a space includes at least one boundary area between the space and external surroundings, and transfer devices for handling the objects. The transfer device and/or an object handled thereby has been identified. The system also includes a management unit to identify a mutual order for the objects at a first time instant on the basis of identification and location data regarding the transfer devices and/or the objects, and to determine a desired mutual order for the objects at a second time instant subsequent to the first time instant. In addition, the management unit can commence the actuation of the transfer devices relative to each other prior to the second time instant in such a way that the desired mutual order for the objects will have been achieved at the second time instant.

The aspects of the disclosed embodiments relate to a logistics system and a method, as well as to a logistics arrangement, for managing objects in a space. Specifically, the aspects of the disclosed embodiments relate to a logistics system for managing the locations of objects into compliance with varying conditions.

### BACKGROUND

Various means of transportation for carrying objects are known in abundance, such as trucks, delivery vans, trains, airplanes and ships. The objects are often loaded in a specific sequence, such as for achieving a specific position for the center of gravity, or in manner favorable from the standpoint of unloading or the sequence of unloading the objects. Generally, in these logistics systems there is a need not only to unload objects but also to receive objects at the same time. Such a situation arises for example when full parcels are unloaded from a delivery van and replaced with empty parcels.

However, a problem in such solutions is for example that the disposition of empty parcels received during the course of unloading may cause problems regarding the unloading of subsequent full parcels, for example in terms of an optimal unloading sequence. This is a particularly serious drawback for example with delivery vans or the like becoming increasingly more automated and unmanned systems. In addition, the loading performed in current solutions is generally permanent all the way to the arrival at the next destination, whereby the conditions possibly changing along the way may cause problems, such as for example changes in the center of gravity of ships as a result of changing weather conditions.

### SUMMARY

In one aspect, the aspects of the disclosed embodiments are directed to eliminate or at least to alleviate drawbacks related to the prior art. According to one embodiment, the invention endeavors to provide such a logistics system and method for managing objects in a space that provides such freight logistics, among other things, for automated driverless-operated delivery vans, whereby for example loading full parcels and receiving empty parcels would be possible. Another objective is also to come up with such a logistics system and method that would enable a change in the center of gravity of transport vehicles to bring it into compliance with fluctuating ambient conditions, and that the unloading and loading of just some objects from the cargo of a transport vehicle would be as easy, optimal and efficient as possible in terms of time.

Certain aspects of the disclosed embodiments are attained with a logistics system according to claim 1.

The logistics system according to the disclosed embodiments for managing objects in a space is characterized by what is presented in claim 1 directed to a logistics system. Further, the method according to the disclosed embodiments for managing objects in a space is characterized by what is presented in claim 11 directed to a method. Still further, the logistics arrangement for managing objects in a space is characterized by what is presented in claim 19 directed to a logistics arrangement.

According to one embodiment, the logistics system for managing objects in a space comprises at least a management unit and one or more space-related boundary areas, as well as a plurality of transfer devices, wherein each transfer device is adapted for handling an object in said space as per instructions from the management unit. The transfer device can be adapted just to handle an object, or alternatively it can also be adapted to support an object during the actual transport. For management, the transfer device and/or the object handled thereby are identified for example with a remote-readable tag, for example with an RFID tag or the like. The logistics system is a system accommodated for example in some transport vehicle, such as a ship, a train, an airplane, a dirigible or the like, for handling and organizing within, into and out of the transport vehicle some objects, such as cargo, containers, parcels, boxes or the like, intended to be carried by the transport vehicle The boundary area, on the other hand, is for example an entry/exit zone, which is arranged between a space and external surroundings of the space and which may accommodate, among other things, a transfer device waiting for objects to be loaded.

According to one example, the management unit is adapted to identify the objects present in a transport space and the mutual order thereof in said space at a first time instant (the current time instant) on the basis of identification and spatial information about transfer devices and/or objects. The spatial information can be obtained for example by means of reading devices set up in a pattern of triangulation or arrangements according to the corresponding prior technology. In addition to this information, the management unit may also gather information relating to the features of transported objects, such as mass, type, size, density, a location desired for the object in said space at a specific time instant, a location desired for the object in said space at a specific geographic coordinate point of the logistics system and the transport vehicle (for example when the freight is to be unloaded or some new freight to be loaded), a type of the object (for example which material the object is made of, such as steel, an explosive or a chemical), whereby the management unit knows to place (for example on the basis of predetermined algorithms or rules or fuzzy logic) the objects according to the features thereof at specific locations in a space, such as for example to place an explosive or a chemical at a ventilated location in consideration of safety issues or at a location separated from foodstuffs and, respectively, to place certain objects in a refrigerated or heated section.

It should be noted that said information can be incorporated in an identifier, for example in an RFID tag, or alternatively, it may be stored by some party in a database arrangement accessible to the management unit for reading. It should be specifically noted that, according to one example, the information can be updated into a database arrangement in the middle of an ongoing transport for bringing it into compliance for example with changes in ambient conditions, such as altered route plans, whereby the management unit is preferably able to define new locations for the objects in said space for the best agreement with the altered ambient conditions. Such a situation may arise, for example, if the next port of call intended for a ship is replaced by another, whereby it may be beneficial to move objects intended for the original port further away from the boundary area and, respectively, to move objects intended for the new, subsequently scheduled other destination, to the boundary area or at least closer to it. Said handling of objects is commenced according to the invention well before arriving at a destination, such that the objects are present at desired locations as the transport vehicle arrives at the destination.

The management unit is further adapted to determine a desired mutual order for the objects or at least a (desired) location for one object at a second time instant subsequent to said first time instant. The management unit is also adapted to commence the handling of said objects relative to each other by means of transfer devices prior to said second time instant, such that said desired mutual order of objects will have been achieved at said second time instant. This can be carried out with several options, like for example in such a way that, pertinent to an object, either the tag or other database carries a time stamp or a coordinate point or the like upon reaching of which the object must have a specific location in said space of the transport vehicle.

The logistics system may also be adapted to acquire information pertinent to ambient conditions at an upcoming temporal and/or coordinate point, such as for example weather information or topological information. The system may for example comprise weather information receiver equipment, a weather radar or equipment intended for the reception of satellite data. Thus, should it be known, for example, that the wind in a certain direction will gain power (direction and strength, for example), or that the storm will become stronger or that the transport vehicle will be subjected to tilting as a result of terrain topology, the objects can be relocated in such a manner that the transport vehicle shall have a center of mass or gravity as desired upon the arrival at said time instant or location.

According to one example, the center of gravity in a logistics system as a result of said management has shifted substantially and become beneficial in view of the anticipated weather condition, such as for example to a location towards the wind and to a lower level, which can have a particularly beneficial effect for example on the behavior of a ship at sea. According to one example, the management system is able to acquire environmental information for example from a ship's active monitoring system with regard to the ship's condition, such as whether the ship is listing in any direction, and on that basis to activate the displacement of objects in such a manner that the ship is set in an appropriate or desired position either from the standpoint of safety and/or consumption or running or seafaring characteristics. Said feature renders possible for example autonomous ships or delivery vans or the like.

According to one example, the location of a center of gravity can be changed by moving said objects as per instructions from the management unit for example in such a way that the center of gravity is a particularly beneficial example from the standpoint of movement, draft, driving, running or parking position, fuel consumption or off-road mobility of the logistics system. The center of gravity of a logistics system and thereby a transport vehicle can be managed by moving the objects in any one or more X/Y/Z directions, or even by rotating an object around a specific point or axis. According to one embodiment, it is additionally possible that the logistics system be adapted to receive external control data regarding desired locations for objects at a subsequent time instant.

According to one example of the disclosed embodiments, the space is provided with or has defined therein trajectories, for example in a horizontal XY plane, but possibly also in Z direction and along diagonals, along which trajectories said transfer devices and/or actuation equipment handling the same are adapted to travel. The transfer device is preferably for example a frame traveling along said trajectories by way of rollers and/or tracks. The transfer device can also be an object-handling piece of equipment, for example a hovercraft, an automatic guided vehicle or the like, capable of moving in a space autonomously, as per instructions from management elements, for example along said trajectories. The transfer device can also be implemented by means of magnets, such that the transfer device levitates in a magnetic field and its operation is controlled by means of changing magnetic fields. The transfer device can also support itself for example on the floor of a transport vehicle, but alternatively it may also be supported on ceiling or wall structures, tracks, cables, chains, hoisting equipment or the like. Furthermore, the transfer device may support an object for example from below or above the same. The piece of equipment capable of operating transfer devices in a vertical Z direction can be constructed for example by way of an elevator or a lifting device.

According to one example of the disclosed embodiments, the system comprises positioning equipment, such as a GPS positioner or some other positioning means known from the prior art, the information produced thereby being adapted to be acquired by the management unit. Into the system can be inputted for example a route for a transport vehicle, which the system is tracking by means of geographical information most preferably in real time. The logistics system is indeed most preferably adapted, jointly with the management unit, to produce anticipatory location information (based for example on the inputted route and a current estimation regarding the arrival time at a subsequent coordinate point), on which basis the management unit is adapted to commence the handling of said objects by means of transfer devices for example along said trajectories established in a space, such that the location of a given transfer device, and thereby an object, in said space is at a certain spot of the space as the logistics system arrives at a certain geographic coordinate point according to said anticipatory location information. Such a location in said space is constituted for example by a space or area in connection with a boundary area, or by said boundary area, especially when the geographic coordinate point is a spot where the unloading of freight or objects or the replacement by new ones takes place. Alternatively, such a spot in said space can be other than that, for example a spot significant in terms of the center of gravity or other safety issue, to which the object must be transferred for example because of an upcoming storm, a topological anomaly or other similar situation.

According to one embodiment of the disclosed embodiments, the system comprises a timer device, for example a clock, and is adapted to supply temporal information relevant to a second time instant. Temporal information may consist of so-called anticipatory information, i.e. a piece of information about after how many minutes a certain specific object must be at a given spot of the space. Hence, the management unit is most preferably adapted to commence the handling of said objects by means of transfer devices for example along said trajectories provided in the space, such that the location of a specific transfer device, and thereby that of a desired object, in said space is at a certain spot of the space as the logistics system arrives at said second time instant according to said anticipatory temporal information. It should further be noted that a location in said space can be some other spot, for example a space or area in connection with a boundary area, said boundary area.

According to one example, the management unit is adapted to determine the fastest and shortest route for at least one transfer device or object for example along said trajectories provided in a space to another spot in said space, such as for example from current location to boundary area.

According to one example, the system comprises at least one vacant transfer device, most preferably an identified (identified e.g. with an RFID tag) transfer device, which is adapted to be movable for example along said trajectories provided in a space. Such a transfer device can be used for moving for example essentially into said boundary area and for managing an object to be introduced into a space, such as for picking it up and carrying it into the space to a certain allocated spot. According to one example, the system can have for example at least 2 vacant transfer devices, especially if the system comprises two or more boundary areas. It should be noted that said boundary area can be external of said space (i.e. the actual cargo space), thereby enabling a total utilization of the space (i.e. the actual cargo space) for the duration of transport.

The logistics system, arrangement and method described in this document for managing objects in a space can be applied and utilized for example in a container ship and particularly in the management of features typical thereof, such as the center of gravity or the load, for example when arriving at a port or in the event of a certain weather phenomenon. In addition, possible applications include other means of transportation intended for carrying objects, such as trucks, delivery vans, trains, aircraft heavier than air and lighter than air, such as for example dirigibles and the like. Especially with regard to dirigibles, the disposition of a load in view of improving the handling characteristics of a dirigible, as well as for facilitating or optimizing the loading and mooring, is extraordinarily important, among other things, for achieving and/or sustaining optimal buoyancy.

The aspects of the disclosed embodiments offer distinct advantages over the prior art, such as for example the aspects of the disclosed embodiments generally enable freight logistics for automated, driverless-operated, unmanned delivery vans or other such transport vehicles. According to the aspects of the disclosed embodiments, the automated delivery van has for example an ability to transfer parcels or other objects to be unloaded, even prior to an unloading site, into a boundary area to be ready and at the same time to organize objects remaining in the cargo space in such a way that the objects possibly picked up from the unloading site fit in their places and preferably even in such a way that the achieved center of gravity is within desired boundaries or otherwise favorable and/or that the mutual order of objects is optimal in consideration of the next unloading site, in other words, those to be unloaded next are already in the proximity of boundary areas or in an otherwise favorable position. The aspects of the disclosed embodiments also make it possible that the center of gravity of transport vehicles be changed in the middle of a journey, for example to comply with changing ambient conditions or to become optimal in terms of fuel consumption or some other parameter, such as for example to comply with altered route plans. Hence, the invention also enables a rapid and easy unloading and loading of objects, as well as also time and fuel savings for transport vehicles. These benefits, in particular, are multiplied in a larger scale, wherein the logistics system according to the invention will be utilized in a logistics arrangement that comprises a plurality of transport vehicles in communication with each other.

### DESCRIPTION OF THE FIGURES

In the next section, preferred embodiments of the disclosed embodiments will be described in slightly more detail with reference to the accompanying figures, in which

FIGS. 1-3 show a few exemplary logistics systems according to one preferred embodiment,

FIGS. 4-5 show a few exemplary transfer devices according to one preferred embodiment,

FIG. 6 shows one exemplary object managed by a logistics system according to one preferred embodiment,

FIGS. 7-10 show a few exemplary implementations according to the disclosed embodiments for a logistics system and a logistics arrangement according to one preferred embodiment,

FIG. 11 shows one exemplary logistics system and logistics arrangement and a communication system thereof according to one preferred embodiment, and

FIG. 12 shows one exemplary feature about a logistics system according to one preferred embodiment.

### DETAILED DESCRIPTION OF THE FIGURES

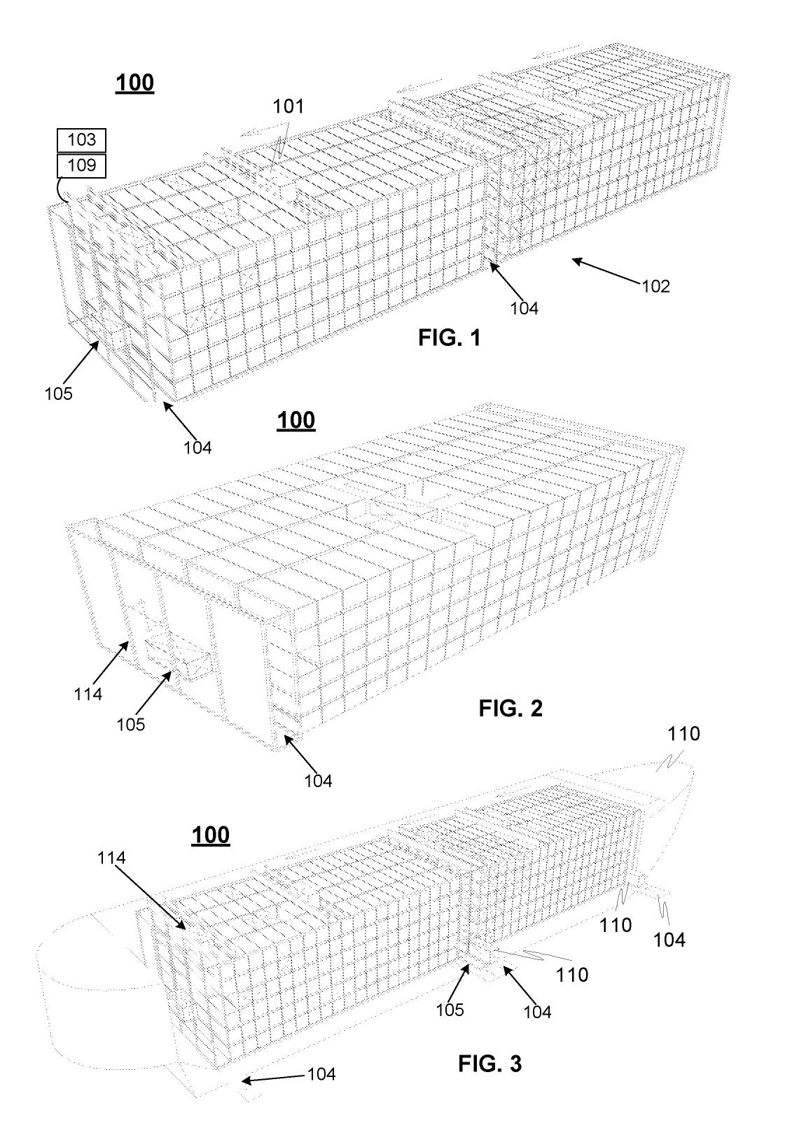

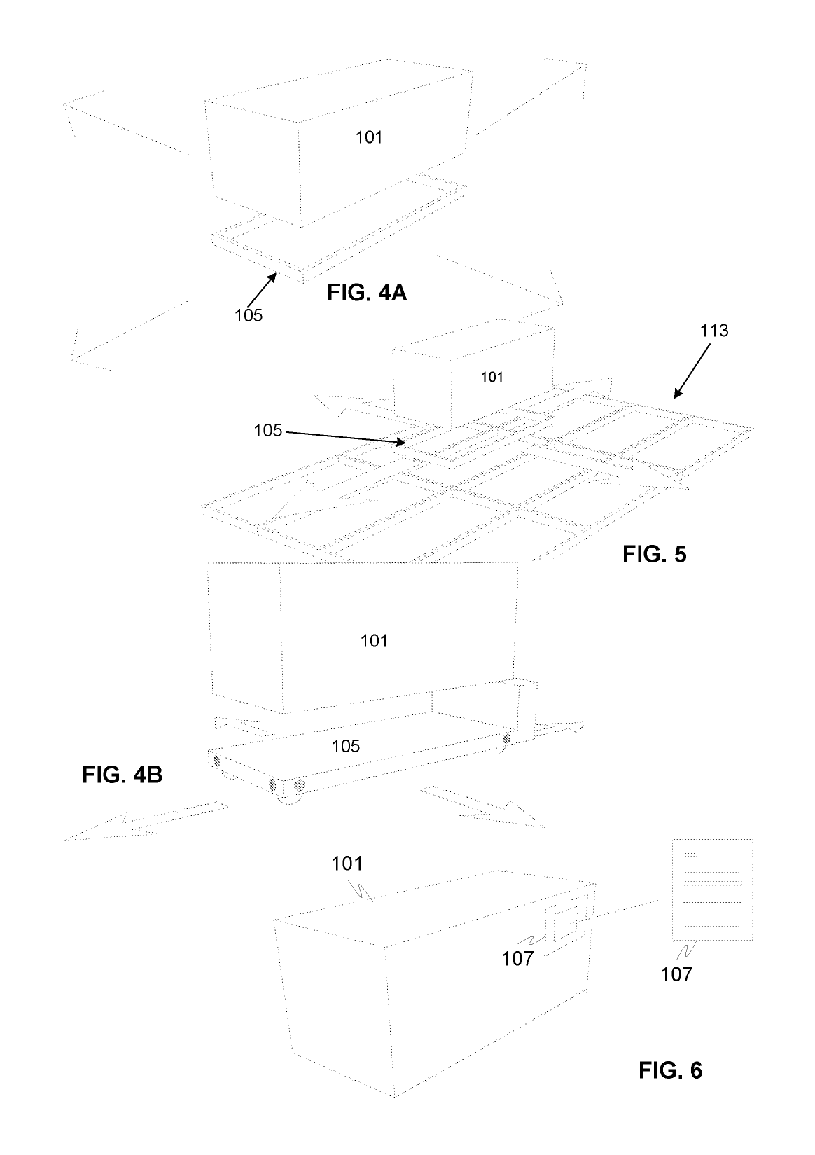

FIGS. 1-3 show a few exemplary logistics systems 100 and FIGS. 4-5 exemplary transfer devices 105 according to one preferred embodiment. In addition, FIG. 6 shows one exemplary object 101 managed by a logistics system according to a preferred embodiment.

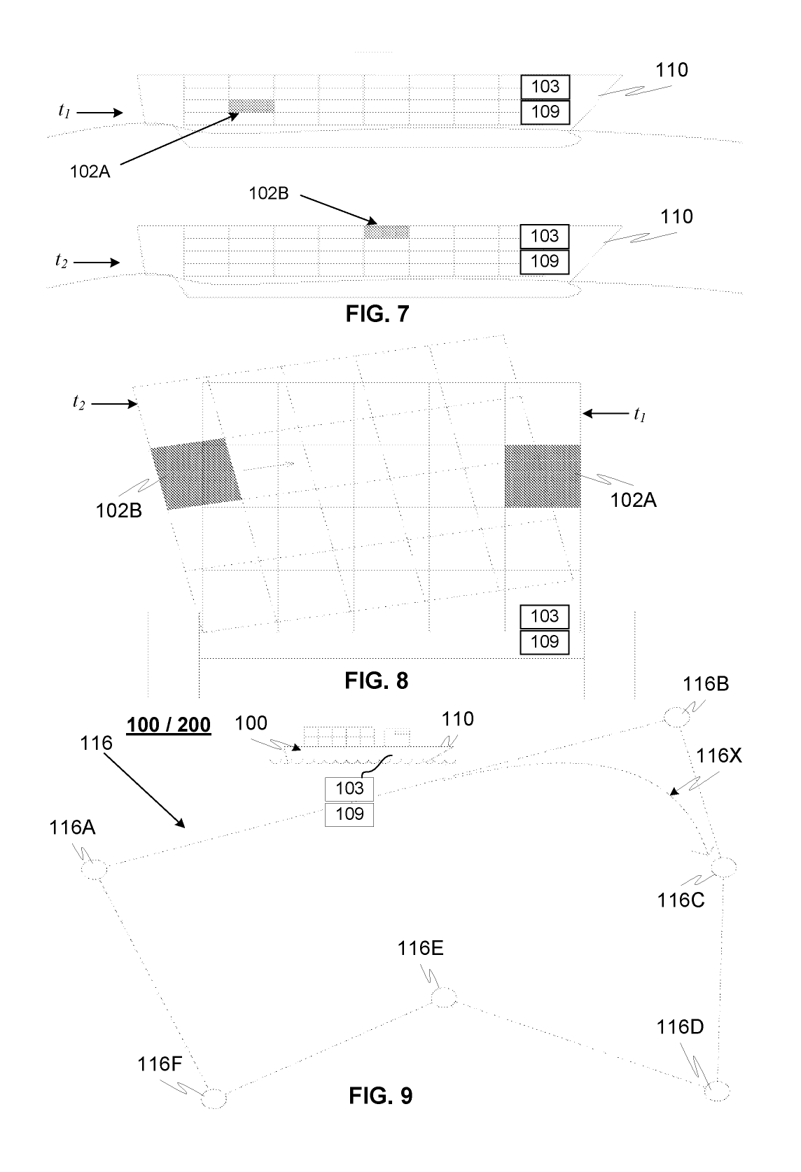

The logistics system 100 is intended for managing objects 101 in a space 102, such as for example in the hold of a ship 110 (FIGS. 3, 7). The system comprises a management unit 103, as well as one or more boundary areas 104 in connection with the space 102. The boundary area 104 is most preferably an entry/exit zone, which is arranged between the space 102 and external surroundings of the space and which may accommodate, among other things, a transfer device 105 waiting for or removing the objects 101 to be loaded or unloaded.

The system further comprises a plurality of transfer devices 105, wherein each transfer device 105 is adapted for handling the object 101 in said space 102 according to instructions from the management unit 103. For management, the transfer device 105 and/or the object 101 handled thereby is identified for example with a remote-readable tag 107, for example with an RFID tag or the like.

According to one example of the disclosed embodiments, the space 102 is provided with or has defined trajectories 113 therein, for example in a horizontal XY plane (especially FIGS. 4A and 5), but possibly also in a Z direction (FIGS. 1-3) and along diagonals. The system has its transfer devices 105 preferably adapted to travel along said trajectories 113. The transfer device 105 is preferably for example a frame 105 which is able to travel by means of rollers and/or tracks, air cushions, magnetic fields or the like along said trajectories. The system also comprises a piece of equipment 114, which is capable of moving the transfer devices in a vertical Z direction and which can be implemented for example by way of an elevator or a hoisting device. It should be noted that there can be several XY planes one above the other (for example FIGS. 1-3), between which the objects can be transferred during transport for optimizing a desired space or a state matching the ambient conditions.

According to one example, the transfer device 105 can also be an automatic guided vehicle as shown in FIG. 4B, or some other, essentially autonomous unit which is able to move with a remarkable freedom in the space 102 either along at least partially pre-designed routes or optionally, for example by the application of fuzzy logic, to work out its own routes. The logistics arrangement 100 may also comprise a plurality of various transfer devices.

It is also notable that the space 102 includes a vacant space 104, 120 (FIG. 12) with the size of at least one object, which enables manipulation of objects relative to each other by way of said vacant space in an X, Y and/or Z direction. The larger said vacant space or with a size for more and more objects, the faster and logistically/computationally easier is the handling of said objects in the space.

The logistics system may also comprise communications equipment 109 or the like for acquiring information related to ambient conditions either online or at an upcoming temporal and/or coordinate point, such as for example weather data or topological data. The system may for example comprise weather information receiving means, a weather radar, or equipment apt for ambient monitoring, for example a radar or a camera, or the equipment 109 intended for the reception of satellite information. Consequently, if for example the wind in a given direction is known to become more powerful (for example direction and strength) or the storm to gain intensity or the transport vehicle to encounter an inclination resulting from topography, the objects 101 can be shifted in such a way that the transport vehicle has a center of mass or gravity as desired upon the arrival at said time instant or location (cf. especially FIGS. 7 and 8).

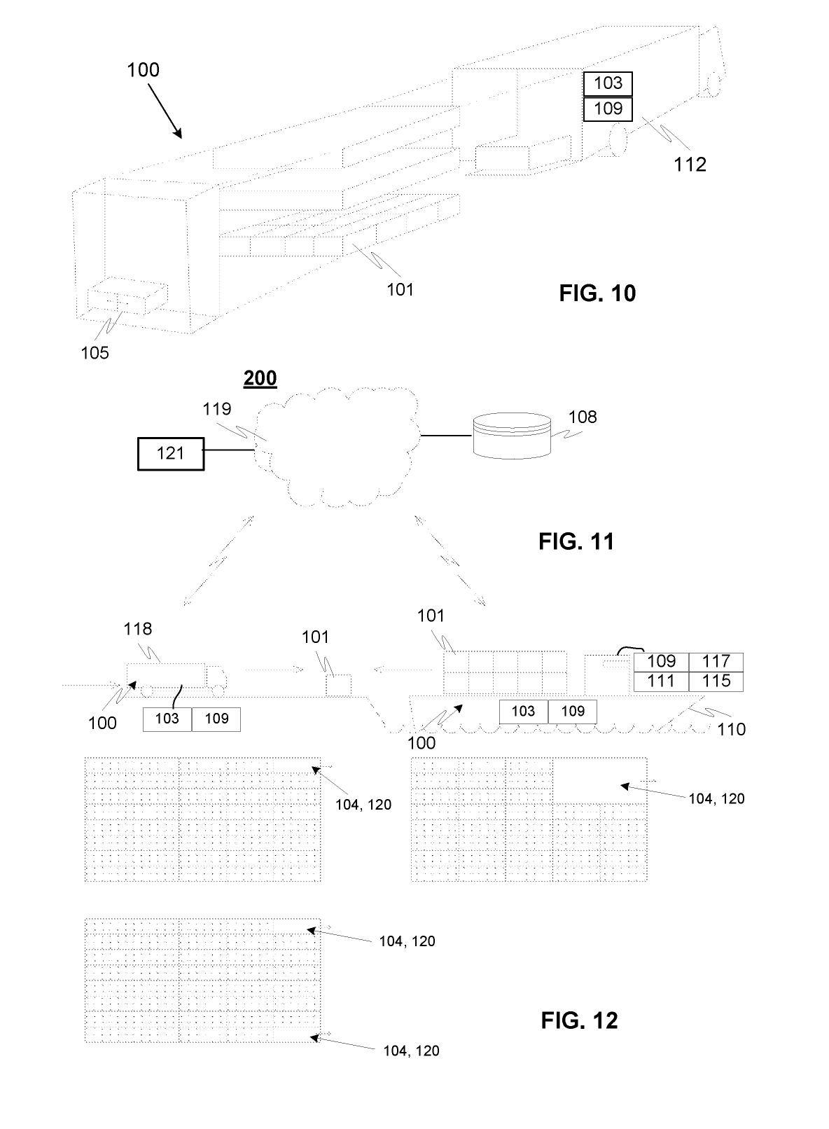

The management system 103 can also acquire ambient data or other information from an active monitoring system 111 aboard the transport vehicle, such as a ship 110. The monitoring system may supply information regarding for example the condition of a transport vehicle, such as the ship 110, like whether the ship is for example listing in any direction. Based on said information, the management system 103 may activate a transfer of the objects 101 so as to bring the ship 110 or the like to an appropriate position either in terms of safety and/or consumption or handling or running characteristics. Said feature makes it possible to have for example autonomous ships or delivery vans 112 (FIG. 10), but it also enables vehicular traffic and logistic flows to be otherwise optimized.

FIGS. 7-11 illustrate a few exemplary implementations of the disclosed embodiments for a logistics system 100 and a logistics arrangement 200 according to one preferred embodiment of the disclosed embodiments. In accordance with the disclosed embodiments, the logistics system 100 has its management unit 103 most preferably adapted to identify objects 101 present in a cargo space 102 and the mutual order thereof in said space at a first time instant (at a current time instant) on the basis of identification and location data of transfer devices 105 and/or the objects 101. In addition to this information, the management unit is also capable of gathering information pertinent to the characteristics of objects being carried, for example from an identifier 107 or alternatively from a database arrangement 108. Moreover, the management unit 103 is adapted to determine a desired mutual order for the objects 101 or a (desired) location for at least one object in the space 102 at a second time instant subsequent to said first time instant.

For example in the implementation of FIG. 7, the object can have a location 102A in the space 102 at a first time instant t₁. Based on the information obtained thereby, the management unit is able to determine for the object a new location 102B for a subsequent time instant t₂, such that the transport system's center of gravity will be favorable at said subsequent time instant t₂ on the basis of said topological data.

FIG. 7 shows another exemplary implementation, wherein the entire transport system at a first time instant t₁ has a certain center of gravity. Based on the information obtained thereby, for example on changing topological data or other information, the management unit is able to determine for the object a new location for a subsequent time instant t₂, such that the transport system's center of gravity will be favorable at said second time instant t₂ on the basis of said topological data.

In the aforesaid implementations related to FIGS. 7 and 8, the desired condition for the time instant t₂ can be achieved for example by shifting heavy objects onto one side of the transport vehicle and lighter ones onto the other side.

According to the disclosed embodiments, the management unit 103 is adapted to commence handling the objects 101 relative to each other by means of the transfer devices 105 prior to said second time instant t₂, such that a desired mutual order for the objects 101 will have been achieved at the second time instant t₂. This can be carried out with several different options as presented elsewhere in this document.

According to one example of the disclosed embodiments, the system comprises positioning means, such as a GPS positioner or some other positioning element known from the prior art, the information supplied thereby being adapted to be acquired and used by the management unit 103. The system can for example be supplied with a route (116) for a transport vehicle (FIG. 9), which is tracked by the system with the assistance of location data most preferably in real time. The route comprises for example designated loading sites 116A-116F, such as for example harbors or other possible loading sites. It should be noted that, according to one example, the ship can for example report its location and what has been estimated thereby as a time of arrival at a certain point, as well as objects to be left and/or picked up there. The transport vehicle or its logistics system 100, and particularly its management unit 103, can here be in communication with a management arrangement 121 of the logistics arrangement 200, which is able to coordinate other units included in the logistics chain, such as for example transport vehicles or the logistics systems 100 and the management units 102 thereof, in order to make these in turn capable of functioning as described elsewhere in this document. In this case, it is according to the disclosed embodiments that some other ship, for example a smaller vessel, is able to receive said information for example by way of the management arrangement 121 of the logistics arrangement 200 and to arrive at this particular point either for bringing and/or receiving objects. According to the disclosed embodiments, the logistics systems of both ships may commence a transfer of the relevant objects beforehand in such a way that, upon arrival at the aforesaid point, the objects to be left there are preferably present either within or in the proximity of the boundary area of this particular ship's logistics system or in an otherwise optimal or desired location in the space 102.

It should be noted that the system, for example the logistics system 100 and especially the management unit 103 of a transport unit, can be supplied in the middle of a transport for example with a route change 106X, whereby the management unit 103 can determine a new mutual arrangement for objects in its space. Said information for example about route changes can be provided for example from a higher level into the management arrangement 121 of the logistics arrangement 200 or into the database 108, wherefrom the management unit 103 may retrieve the information or from where said information is delivered to the management unit 103.

According to one embodiment, the management unit 103 may commence handling the objects 101 by means of the transfer devices 105 for example in such a way that, when approaching a harbor, the objects 101 to be left there are shifted already in advance, i.e. prior to arriving at the port, into or to the proximity of a boundary area 104 for rapid unloading. The management unit 103 may commence handling the objects 101 based for example on an inputted route 116 and on a current estimation regarding the time of arrival at the subsequent coordinate point by means of location data supplied by the positioning equipment 115, or based alternatively on route changes 116X.

According to one embodiment of the disclosed embodiments, the system may also comprise a timer device 117, for example a clock, and is adapted to supply temporal information pertinent to said second time instant, whereby, on the basis of the information provided by said timer device 117, the management unit 103 is able to commence handling the objects 101 in advance prior to said second time instant, such that a desired order to the objects 101 will have been achieved upon arrival at said second time instant.

FIG. 11 further shows one exemplary logistics system 100, a logistics arrangement 200 and a communications system 119 for the same, according to one preferred embodiment of the disclosed embodiments, wherein for example the logistics systems are able to acquire information pertinent to objects being transported and to communicate with each other by way of the communications system 119 and/or the logistics arrangement 200 which can be implemented for example by means of the internet or cloud services. According to one preferred embodiment, the logistics arrangement 200 comprises a higher level management arrangement 121, which is able to communicate with the management units 103 of transport vehicles' logistics systems 100 and to coordinate the order between objects carried thereby in a space of said transport vehicles, most preferably by means of the management units 103. The management unit 103 for the logistics system 100 of the disclosed embodiments, like also the management arrangement 121 for the logistics arrangement 200, can be implemented at least partially with computer program products and codes, at least some of which can be located and at least some of which can be run or managed in an external communications system, such as for example in a cloud service.

In the example illustrated in FIG. 11, the ship 110 approaching a harbor is able to communicate information to a communications system, as well as to the logistics arrangement 200, and still further to the higher level management arrangement 121, and even further for example to a delivery van 118 or some other means of transportation, about its arrival time and details regarding the objects 101 to be left at the port, such as the number, size and/or mass, whereby the delivery van 118 is able to anticipate a volume required in its cargo space and to commence transferring into the delivery van's boundary area those objects that are possibly left at the port, as well as a transfer of objects remaining in the delivery van in such a way that for example the center of gravity will be optimal or within desired boundaries, and/or in such a way that the order of objects carried by the delivery van upon a departure from the port will be optimal for example in view of the upcoming unloading sites.

Respectively, the delivery van 118 approaching the harbor is able to communicate to the ship 110 information about objects to be delivered thereto, the management unit 103 of the ship's 110 logistics system 100 being able to commence already in advance the handling of objects present in the ship's logistics system in such a way that the order of loading the ship and/or objects remaining there will be optimal upon a departure from the port for example in terms of the center of gravity or other characteristics. It should be noted that said information can be supplied to transport vehicles most preferably by way of the logistics arrangement 200 and the higher level management arrangement 121.

The logistics arrangement 200 comprises most preferably several transport vehicles as well as the management arrangement 121. Each of the several transport vehicles further comprises its own lower level logistics system 100 as well as data transfer means 100 for carrying out a data transfer between the management units 103 of the transport vehicles' logistics systems 100 and the logistics arrangement's 200 management arrangement 121. According to one example, the management arrangement 200 is adapted to receive information from the management units 103 and to thereby determine a desired mutual order for the objects of at least one first transport vehicle at a second time instant t₂, which is subsequent to a first time instant t₁, on the basis of information provided by the management unit 103 of some other transport vehicle, and to commence, prior to said second time instant, the actuation of said first transport vehicle's transfer devices relative to each other in such a way that said desired mutual order of the first transport vehicle's objects will have been achieved at said second time instant.

What has been described above are but a few embodiments for a solution of the disclosed embodiments. The principle according to the disclosed embodiments can be naturally modified within the scope of protection defined by the claims, regarding for example implementation details as well as fields of use. What should be appreciated in particular is that the logistics system and method described in this document for managing objects in a space can be applied and utilized for example in a container ship, and especially in the management of features typical thereof, such as the center of gravity or the load, for example upon arriving at a port or in the event of a certain weather phenomenon. Further possible applications include other means of transportation intended for carrying objects, such as trucks, delivery vans, trains and the like. One example of the transport vehicle may comprise freight carrying lighter-than-air aircraft whose flight position or position in mooring can be adjusted with a logistics system of the disclosed embodiments. Respectively, the aspects of the disclosed embodiments can also be applied in submarines.

1. A logistics system for managing objects in a space, said space containing at least one boundary area between the space and external surroundings of the space, and wherein the system comprises:
a plurality of transfer devices, wherein each transfer device is configured for handling an object in said space, and wherein the transfer device and/or an object handled thereby has been identified,
a management unit, which is configured to:
identify a mutual order for objects in said space at a first time instant on the basis of identification and location data regarding the transfer devices and/or the objects,
determine a desired mutual order for objects at a second time instant, which is subsequent to said first time instant, and
commence the actuation of said transfer devices relative to each other prior to said second time instant in such a way that said desired mutual order for the objects will have been achieved at said second time instant.

2. A system according to claim 1, wherein said space is the cargo space of a transport vehicle, for example the freight space of a truck or a delivery van or the cargo space of a train, an airplane, a lighter-than-air aircraft, or a ship.

3. A system according to claim 1, wherein the system comprises a database, which comprises information pertinent to an object, such as a mass of the object, a volume, a desired location for the object in said space at a specific time instant, a desired location for the object in said space at a specific geometric coordinate point of the logistics system, or a type of the object.

4. A system according to claim 1, wherein the system comprises positioning means and is configured to supply the management unit with anticipatory location data, whereby the management unit is configured to commence the handling of said objects in such a way that the location of a specific object in said space is in connection with a boundary area or elsewhere in said space upon an arrival of the logistics system at a certain geographic coordinate point according to said anticipatory location data.

5. A system according to claim 1, wherein the system comprises a timer device and is configured to supply temporal data pertinent to said second time instant, whereby the management unit is configured to commence the handling of said objects in such a way that the location of a specific object in said space is in connection with a boundary area or elsewhere in said space upon an arrival of the logistics system at said second time instant according to said anticipatory temporal data.

6. A system according to claim 1, wherein the system comprises weather information receiver means and is configured to supply the management unit with anticipatory weather information regarding for example the strength and direction of the wind, whereby the management unit is configured to commence the handling of said objects in such a way that the location of at least some objects in said space at the second time instant is such that the logistics system's center of gravity has become substantially more favorable so as to comply with the anticipated weather condition.

7. A system according to claim 1, wherein the system is configured to receive or acquire anticipatory and/or real time measurement information pertinent to the topology of a route, the features of a surface, such as the inclination or slipperiness of a surface, information pertinent to sea state, such as wave length or height information, temperature information, information related to the direction and strength of sunlight, information pertinent to a transport vehicle, such as information related to tire pressure, suspension load or running speed, and wherein the management unit is configured to commence the handling of said objects in such a way that the location of at least some objects in said space at a second time instant is such that the logistics system's center of gravity or the location of objects has become substantially more favorable so as to comply with the anticipated and/or real time measurement information.

8. A system according to claim 1, wherein the management unit is configured to handle said objects in such a way that the location of at least some objects in said space at a second time instant is such that the logistics system's center of gravity is more favorable from the standpoint of the logistics system's mobility.

9. A system according to claim 1, wherein the management unit is configured to determine the fastest or shortest route for at least one transfer device to a certain second point in said space, such as for example from current location to boundary area.

10. A system according to claim 1, wherein the system comprises at least one vacant transfer device, which is configured to be movable for delivering into the space and managing an object to be introduced essentially into said boundary area in the space.

11. A system according to claim 1, wherein the space is provided with a trajectory, which comprises actuation implements intended for the transfer devices and/or the objects and extending a horizontal XY plane, and/or wherein the trajectory provided in the space further comprises an implement which actuates the transfer devices and/or the objects in a vertical Z direction, such as for example an elevator or a hoisting device.

12. A method for managing objects in a space, said space having at least one boundary area between the space and external surroundings of the space, and which comprises:
handling objects in said space by means of transfer device, wherein the transfer device and/or an object handled thereby has been identified,
identifying a mutual order for objects in said space at a first time instant on the basis of identification and location data regarding the transfer devices and/or the objects,
determining a desired mutual order for objects at a second time instant, which is subsequent to said first time instant, and
commencing the actuation of said transfer devices relative to each other prior to said second time instant in such a way that said desired mutual order for the objects will have been achieved at said second time instant.

13. A method according to claim 12, wherein a database contains information pertinent to an object, such as a mass of the object, a volume, a desired location for the object in said space at a specific time instant, a desired location for the object in said space at a specific geometric coordinate point of the logistics system, and/or a type of the object, said information being used for determining a desired order for the locations of said objects at said second time instant.

14. A method according to claim 12, said method comprising commencing the handling of said objects on the basis of anticipatory location data in such a way that the location of a specific object in said space is in connection with a boundary area or elsewhere in said space upon an arrival of the logistics system at a certain geographic coordinate point according to said anticipatory location data.

15. A method according to claim 12, said method comprising commencing the handling of said objects on the basis of temporal data pertinent to said second time instant in such a way that the location of a specific object in said space is in connection with a boundary area or elsewhere in said space upon an arrival of the logistics system at said second time instant according to said anticipatory temporal data.

16. A method according to claim 12, said method comprising commencing the handling of said objects on the basis of anticipatory weather information regarding for example the strength and direction of the wind in such a way that the location of at least some objects in said space at a second time instant is such that the logistics system's center of gravity has become substantially more favorable so as to comply with the anticipated weather condition.

17. A method according to claim 12, which comprises actuating said objects in such a way that the location of at least some objects in said space at a second time instant is such that the logistics system's center of gravity is more favorable from the standpoint of the logistics system's mobility.

18. A logistics system or method, wherein the space includes a vacant space the size of at least one object in such a way that the objects are freely movable relative to each other across said vacant space in an X, Y and/or Z direction.

19. A logistics arrangement, wherein the logistics arrangement comprises several transport vehicles as well as a management arrangement, and wherein each of the several transport vehicles comprises a logistics system according to claim 1 as well as data transfer means for carrying out a data transfer between the management units of the transport vehicles' logistics systems and the logistics arrangement's management arrangement, wherein the management arrangement is configured to receive information from the management units and to thereby determine a desired mutual order for the objects of at least one first transport vehicle at a second time instant, which is subsequent to a first time instant, on the basis of information provided by the management unit of some other transport vehicle, and to commence, prior to said second time instant, the actuation of said first transport vehicle's transfer devices relative to each other in such a way that said desired mutual order of the first transport vehicle's objects will have been achieved at said second time instant.
